(19) United States
(12) Patent Application Publication
(10) Pub. No.: US 2022/0227273 A1
(43) Pub. Date: Jul. 21, 2022

(54) VEHICLE SEAT PANEL WITH DISCONTINUOUS FOAM LAYER

(71) Applicant: FAURECIA AUTOMOTIVE SEATING, LLC, Auburn Hills, MI (US)

(72) Inventors: Aurelien FRANCOIS, Berkley, MI (US); Olivier BOINAIS, West Bloomfield, MI (US)

(21) Appl. No.: 17/153,428

(22) Filed: Jan. 20, 2021

(51) Int. Cl. B60N 2/58; B29C 44/18; B29C 44/08

(52) U.S. Cl. CPC B60N 2/5891; B29L 2031/58; B29C 44/08; B29C 44/181

(57) ABSTRACT

A method of making a vehicle seat includes molding a discontinuous layer of foam on a non-decorative side of a decorative layer of material to form a seat panel that subsequently forms part of an exterior surface of the seat. A portion of the decorative layer is positioned in a foam molding cavity, and another portion of the decorative layer is excluded from the molding cavity. The excluded portion can be temporarily folded into a loop and reside in a secondary cavity of the molding tool during molding. The discontinuous layer of foam can be wider than the molding tool with foam portions selectively positioned along the decorative layer.

### TECHNICAL FIELD

Noon The present disclosure relates to vehicle seats and, more specifically, to decorative trim of vehicle seats.

### BACKGROUND

An advancement known as Cover Carving Technology (CCT) has recently been brought to the vehicle seating market. CCT offers the ability to form very sharp feature lines in the decorative surface of upholstery materials such as leather or textiles that were previously considered non-formable with conventional polymer forming methods such as molding or thermoforming. Unlike synthetic polymer-based films, such upholstery materials cannot be simply heated and pressed against a molding tool and expected to take the shape of the mold surface when subsequently cooled.

An example of a technique with one or more elements in common with CCT is disclosed in U.S. Pat. No. 10,710,481 by Etienne, et al. The Etienne patent discloses a method in which a foamable material is applied to a carrier and subsequently pressed against a covering material in a mold. The foamable material expands and hardens in the mold with the outer surface of the covering material taking the shape of the mold surface. Limitations of the technology include size limitations and limitations on placement of the foam layer. For example, the total width of the foam layer is limited to the width of the mold, and the process sometimes results in the placement of foam material in locations where it is unnecessary.

### SUMMARY

In accordance with one or more embodiments, a method of making a vehicle seat includes the step of molding a discontinuous layer of foam on a non-decorative side of a decorative layer of material to form a seat panel that is subsequently attached to a vehicle seat structure to form at least a portion of an exterior surface of the vehicle seat.

In one or more embodiments, the discontinuous layer of foam is molded in a single molding operation.

In one or more embodiments, the method includes forming a loop in the decorative layer of material between separate first and second areas of the decorative layer of material before the step of molding.

In one or more embodiments, the decorative layer of material is arranged so that a portion of the non-decorative side of the decorative layer of material is facing itself during the step of molding.

In one or more embodiments, a portion of the decorative layer of material located between separate first and second areas of the decorative layer of material is excluded from a foam molding cavity during the step of molding.

In one or more embodiments, a portion of the decorative layer of material is disposed in a foam molding cavity of a molding tool during the step of molding and another portion of the decorative layer of material is disposed in a secondary cavity of the molding tool during the step of molding.

In one or more embodiments, the discontinuous layer includes a first portion molded on a first area of the decorative layer of material and a separate second portion molded on a second area of the decorative layer of material. The method also includes forming permanent concave features in a decorative side of the decorative layer of material at said first and second areas.

In one or more embodiments, the discontinuous layer of foam is formed by transferring a continuous layer of foamable material from a transfer film to the non-decorative side of the decorative layer of material.

In one or more embodiments, the method includes disposing the decorative layer of material between opposing first and second portions of an open molding tool and closing the molding tool to form a foam molding cavity with a portion of the decorative layer of material in the foam molding cavity. A central portion of the decorative layer of material is outside the foam molding cavity after the step of closing and during the step of molding.

In one or more embodiments, a first portion of a foam molding tool includes first and second sections configured to move toward and away from each other. The method also includes disposing a central portion of the decorative layer of material between the first and second sections of the first portion of the molding tool before a step of closing the molding tool.

In one or more embodiments, the decorative layer of material is in sheet form and placed in tension during a step of disposing the decorative layer of material between opposing first and second portions of an open molding tool with forces applied to opposite edges of the decorative layer of material in opposite directions and another force applied to a central portion of the decorative layer of material in a direction transverse to said opposite directions.

In one or more embodiments, separate first and second portions of the discontinuous layer of foam are on opposite left and right sides of a seat back of the vehicle seat when the seat panel is attached to the vehicle seat structure.

In one or more embodiments, wherein separate first and second portions of the discontinuous layer of foam are on opposite left and right sides of a seat bottom of the vehicle seat when the seat panel is attached to the vehicle seat structure.

In one or more embodiments, the seat panel is folded to form a pocket between separate first and second portions of the discontinuous layer of foam when the seat panel is attached to the vehicle seat structure so that a portion of a decorative side of the decorative layer of material faces itself within the pocket.

In one or more embodiments, separate first and second portions of the discontinuous layer of foam have a first orientation relative to each other during the step of molding and a different second orientation relative to each other after attachment to the vehicle seat structure.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

Exemplary embodiments will hereinafter be described in conjunction with the appended drawings, wherein like designations denote like elements, and wherein:

FIG. 1 is a cross-sectional side view of part of a method of making a seat panel from a decorative layer of material in a foam molding tool;

FIG. 2 illustrates a looped portion of the decorative layer of FIG. 1 in a secondary cavity of the molding tool;

FIG. 3 illustrates a layer of foam supported between the decorative layer and a portion of the molding tool;

FIG. 4 illustrates first and second portions of the molding tool brought together to form a foam molding cavity with a portion of the decorative layer in the molding cavity;

FIG. 5 illustrates expansion of the layer of foam in the molding cavity;

FIG. 6 illustrates separation of the first and second portions of the molding tool;

FIG. 7 illustrates removal of the molded part from the molding tool;

FIG. 8 is a cross-sectional view of the molded part;

FIG. 9 is a cross-sectional view of the seat panel after trimming away edges of the molded part of FIG. 8;

FIG. 10 is a top view of a vehicle seat showing an exemplary location of the seat panel along a rear face of the vehicle seat;

FIG. 11 is a perspective view of a molded seat panel illustrated in partial cross-section as part of a seat back;

FIG. 12 is a perspective view of a molded seat panel illustrated in partial cross-section and forming a map pocket along a seat back; and

FIG. 13 is a perspective view of a molded seat panel illustrated in partial cross-section as part of a seat bottom.

### DETAILED DESCRIPTION

Described below is a vehicle seat and a method of making the vehicle seat including molding a layer of foam on a decorative layer of material to form a seat panel of the seat. The method compliments the above-described CCT by enabling formation of a foam layer that is wider than the foam molding tool and by enabling the placement of localized portions of the foam layer at only the desired areas of the seat panel.

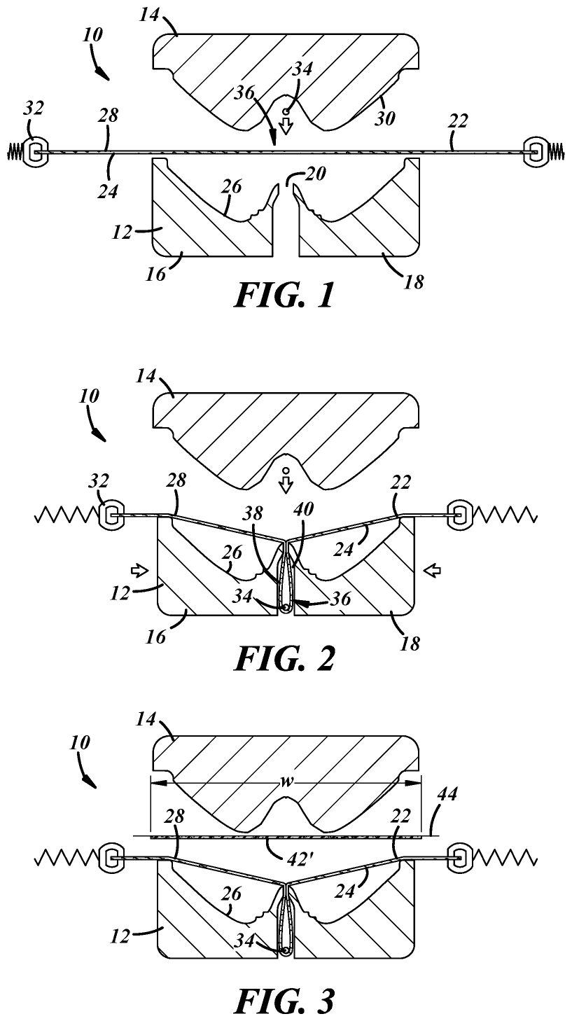

FIGS. 1-9 illustrate an exemplary method of making a vehicle seat that includes forming a seat panel in a foam molding tool 10. The foam molding tool 10 includes a first portion 12 and a second portion 14 and is shown in an open condition in FIG. 1, ready to receive materials for molding. The first and second portions 12, 14 of the tool 10 are moveable toward and away from each other. In this instance, the first portion 12 of the tool 10 is a bottom portion and a cavity side of the tool, the second portion 14 is a top portion and a core side of the tool, and the tool portions 12, 14 are moveable toward and away from each other in the vertical direction.

The first portion 12 of the molding tool 10 includes first and second sections 16, 18 that are moveable toward and away from each other along a direction transverse to the direction of relative movement of the first and second tool portions 12, 14. When moved away from each other as in FIG. 1, an opening 20 is formed between the two sections 16, 18. A decorative layer of material 22 in sheet form is supported between the tool portions 12, 14 with a decorative side 24 of the material facing a mold surface 26 of the first portion 12 and an opposite non-decorative side 28 facing a mold surface 30 of the second portion 14.

The decorative layer of material 22 is a fabric such as leather, a natural and/or synthetic textile, or a polymer-based material (e.g., simulated leather). The fabric is provided with a uniform thickness (e.g., 0.1 mm to 2.0 mm) that is orders of magnitude less than its planar dimensions (e.g., 25 mm to 1 meter) and is characterized by an inability to support its own weight without folding or buckling when the planar dimensions are horizontal as in FIG. 1 and when held by only one edge. The decorative side 24 is intended to form at least a portion of the visible exterior surface of the vehicle seat once attached to an underlying vehicle seat structure. The decorative layer of material 22 may itself be a multilayer material with a different non-decorative backing layer forming the non-decorative side 28, for example.

When first placed between the portions 12, 14 of the open molding tool 10, the decorative layer 22 is supported at least along opposite edges at its perimeter. For example, each opposite edge may be grasped by a clamp 32 and biased away from each other by springs, actuators, or other suitable means so that the decorative layer is taut when oriented horizontally as shown. Such biasing clamps 32 may be referred to as tensioners.

Another tensioner 34 is located on the non-decorative side 28 of the decorative layer 22—i.e., above the decorative layer of material in FIG. 1. The tensioner 34 is moveable with respect to the first tool portion 12 and the decorative layer 22. With the first and second sections 16, 18 of the first tool portion 12 moved away from each other, the tensioner 34 is brought into contact with the decorative layer 22 and, in particular, into contact with the non-decorative side 28 of a central portion 36 of the decorative layer. The central tensioner 34 continues moving toward the first tool portion 12, bringing the decorative side 24 of the decorative layer 22 into contact with the tool portion 12 at the perimeter of the mold surface 26, and bringing the central portion 36 of the decorative layer through the opening 20 between the sections 16, 18 of the first tool portion 12.

The clamps or other tensioners 32 move toward each other and toward the center of the tool 10 in response, permitting more of the decorative layer 22 to be brought within the projected area of the molding tool while maintaining tension in the layer of material 22. In this manner, even non-stretchable fabrics can be used as the decorative layer 22. As shown in FIG. 2, a loop 38 is formed in the decorative layer 22 as it passes through the opening 20 such that a portion of the non-decorative side 28 of the layer 22 is facing itself on the inside of the loop. When the desired amount of the decorative layer 22 has passed through the opening 20, the tensioner 34 stops moving and the sections 16, 18 of the tool portion 12 are moved toward each other such that the decorative layer 22 is clamped therebetween with the loop 38 housed in a secondary cavity 40 of the tool. The secondary cavity 40 may be referred to as a safe chamber—i.e., a chamber in which subsequently introduced foam material will not be able to reach the portion 36 of the decorative layer 22 housed there.

As illustrated in FIG. 3, a layer of foamable material 42′ is then presented facing the non-decorative side 28 of the decorative layer 22. The layer of foamable material 42′ may be an uncured and/or viscous layer of a foam precursor material which has not yet begun to expand into a foam or has not yet fully expanded—e.g., a diisocyante/polyol mixture in the case of polyurethane foam. In this case, the layer of foamable material 42′ is provided on a carrier or transfer film 44. In one embodiment, the layer of foamable material 42′ is sprayed or otherwise deposited on the transfer film 44 in a parallel process while the decorative material 22 is being presented to and arranged in the molding tool 10 as in FIGS. 1 and 2. The layer of foamable material 42′ may for example be sprayed onto an upward-facing surface of the transfer film 44 and then inverted when introduced over the decorative layer 22 in the molding tool 10. In other embodiments, the layer of foamable material 42′ may be deposited directly onto the exposed portions of the decorative layer 22 while in the tool 10, or the layer of foamable material can be poured or injected into a mold cavity formed when the tool 10 is in a closed condition. The layer of foamable material 42′ is continuous in this example and has a width (w) approximately the same as that of the molding tool 10.

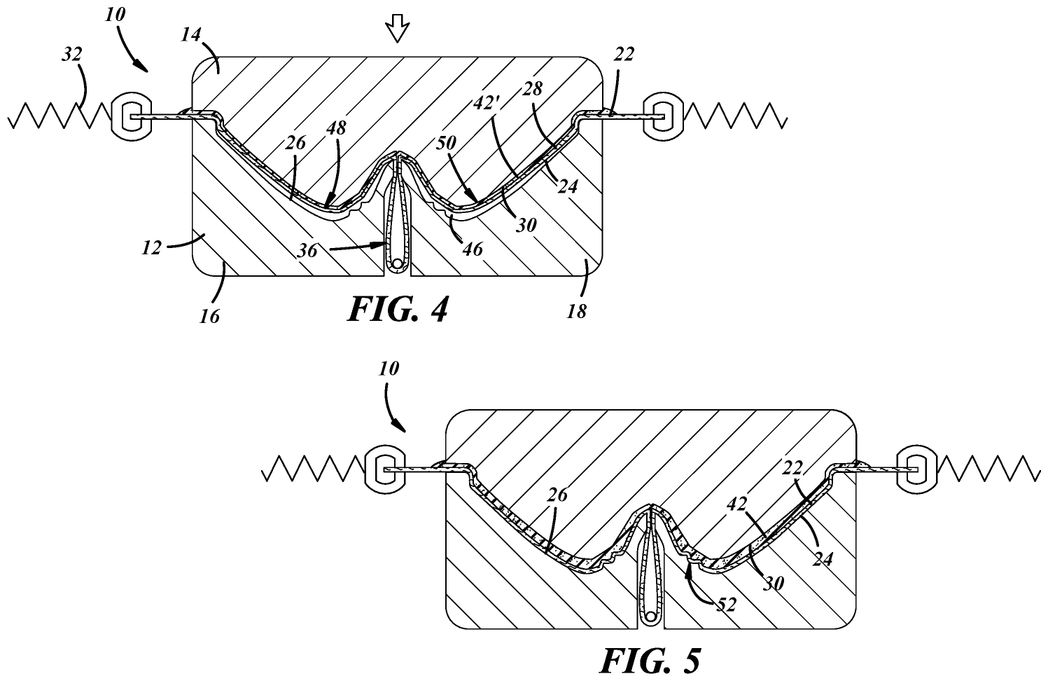

The first and second portions 12, 14 of the molding tool 10 are next moved toward each other to the closed condition as shown in FIG. 4, thereby forming a foam molding cavity 46 between the tool portions 12, 14 defined by the first and second mold surfaces 26, 30. One portion of the decorative layer 22 is thereby positioned in the foam molding cavity 46 while another portion 36 of the decorative layer 22 is excluded from the foam molding cavity. The portion of the decorative layer 22 in the foam molding cavity 46 includes first and second areas 48, 50 respectively located at the first and second sections 16, 18 of the first portion 12 of the tool 10. The carrier film 44 is omitted in FIGS. 4-6 for clarity.

The first and second areas 48, 50 of the decorative layer 22 are on opposite sides of the central portion 36 of the layer 22, which is the portion of the decorative layer excluded from the foam molding cavity 46 when the molding tool 10 is closed. Although the illustrated central portion 36 is at the geometric center of the decorative layer 22 in the illustrated example, this is not required. The central portion 36 is merely located between the first and second areas 48, 50 of the decorative layer 22 and is not intended to have any foam material molded thereon. In some cases, the decorative layer 22 may include a plurality (n) of distinct areas to receive a portion of foam with a corresponding plurality (n-1) of central portions between those areas.

With the tool 10 in the closed condition of FIG. 4, each of the first and second areas 48, 50 of the decorative layer 22, the layer of foamable material 42′, and the optional transfer film 44 is arranged in the foam molding cavity 46. The decorative side 24 of the decorative layer 22 faces one mold surface 26, the layer of foamable material 42′ is in contact with the non-decorative side 28 of the decorative layer, and the transfer film separates the layer of foamable material from the other mold surface 30. To arrive at this stage of the process, the edge tensioners 32 may be configured to permit more of the decorative layer 22 to be pulled within the perimeter of the tool as the cavity 12 and core 14 are brought together.

With the molding tool 10 in the closed condition, the layer of foamable material 42′ expands such that the foam molding cavity 46 is entirely filled with the multiple layers of materials. The foamable material 42′ cures or hardens to form a layer of foam 42 sandwiched between the decorative layer of material 22 and the mold surface 30 as shown in FIG. 5. While some of the foamable material may be permitted to leak from the cavity 46 at the parting line of the tool 10, the pressure from the foam expansion forces the fabric of the decorative layer 22 to conform to the shape of the mold surface 26. When the foamable material cures or hardens, that shape is permanently locked into the decorative side 24 of the decorative layer 22. The material of the foam layer may be formulated to be relatively rigid compared to the types of foam materials typically used as thick cushioning layers of vehicle seats so that the sharpness of the feature lines 52 is maintained after the molded part is removed from the tool. In this manner, very sharp feature lines 52 can be formed into the decorative surface of any type of fabric or upholstery, including non-stretchable materials such as leather or tightly woven textiles. And there is no need to heat the decorative layer of material 22 prior to forming as is typically required when thermoforming polymer-based materials.

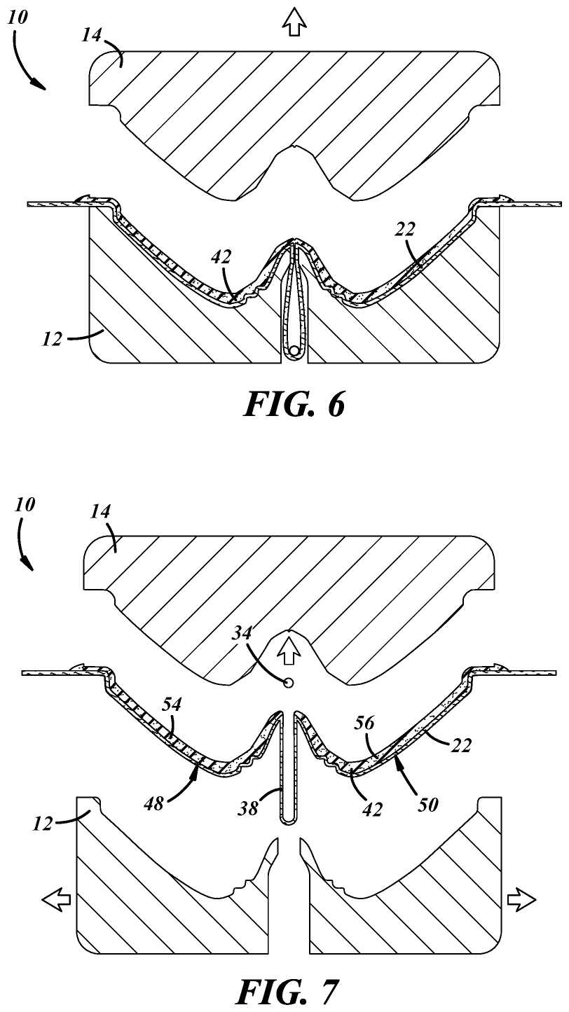

Once the layer of foam 42 is formed, tension is released from the decorative layer 22 and the tool portions 12, 14 are separated as in FIG. 6. The transfer film 44, if used, may be removed once the tool 10 is in the open condition.

The first and second sections 16, 18 of the first portion 12 of the tool 10 are then separated, as in FIG. 7. The layer of foam 42 is thereby made discontinuous with distinct and separate portions. A first portion 54 of the discontinuous layer of foam 42 is on the first area 48 of the decorative layer 22, and a separate second portion 56 of the discontinuous layer of foam is on the second area 50 of the decorative layer. The central tensioner 34 is then moved away from the decorative layer 22 and out of the previously formed loop 38 of material so that the molded part can be removed from the molding tool 10.

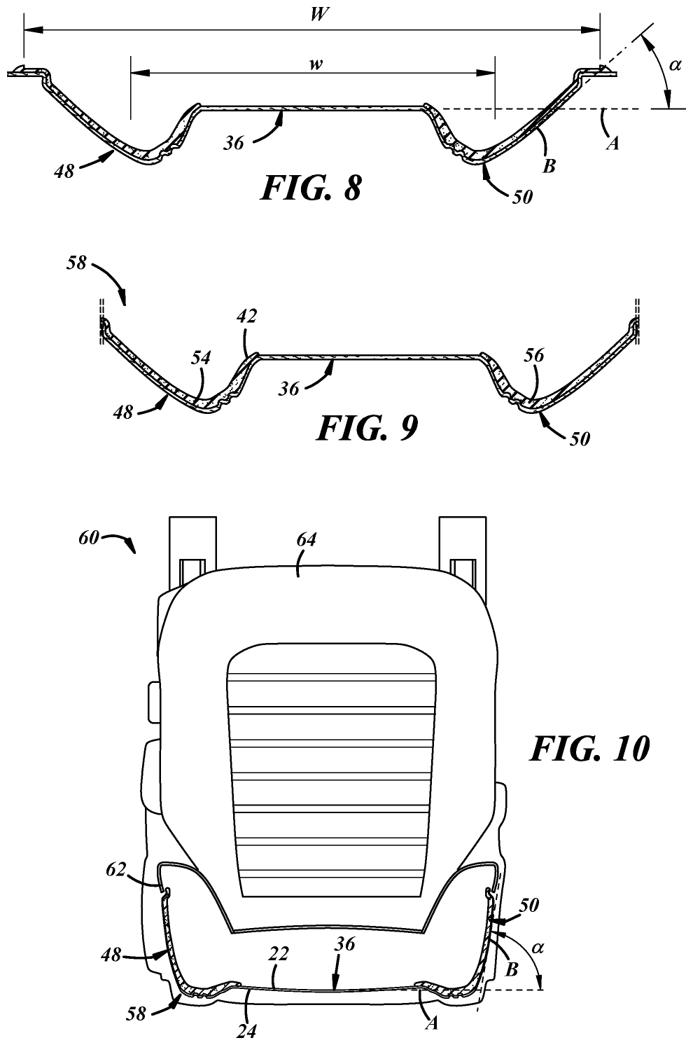

The loop 38 can then be removed by moving the first and second areas 48, 50 of the layer away from each other, as in FIG. 8. The edges of the molded part can then be trimmed away, as shown in FIG. 9. The resulting seat panel 58 includes two relatively rigid areas 48, 50 of foam-backed fabric with separate portions 54, 56 of the discontinuous layer of foam 42 molded onto them and separated by a central portion 36 onto which none of the layer of foam 42 is molded—i.e., the central portion is where the layer of foam 42 is discontinued. The central portion 36 thus retains its flexible and foldable fabric characteristics.

FIG. 10 is a top view of a vehicle seat 60 shown in partial cross-section through a seat back 62 of the seat to illustrate a possible application of the finished seat panel 58. Here, the seat back 62 extends upward from a seat bottom 64, and the seat panel 58 is affixed over an underlying seat structure (e.g., a metal frame or composite load-supporting structure) and/or a layer of cushioning foam to define a portion of the exterior surface of the seat 60. Part of the decorative side 24 of the decorative layer 22 faces away from the seat 60 in a rearward direction with respect to a seat occupant, and other parts of the decorative side of the decorative layer face away from the seat in opposite transverse directions (i.e., left and right) with respect to the seat occupant. The seat panel 58 spans the width of the rear of the seat back 62 and wraps around to the left and right sides of the seat back.

The seat panel 58 can be affixed to the underlying seat structure by any conventional means. For example, the panel 58 may be sewn together with other panels to form a decorative covering for the seat that is slipped over the seat structure at final seat assembly. Or the panel can be affixed to a utility seat covering already on the seat structure via sewing, hook and loop fasteners, adhesive, etc.

Notably, the first and second areas 48, 50 of the decorative layer 22 can be oriented differently when attached to the seat structure than they were during the molding process due to the retention of the fabric-like character of the central portion 36 of the decorative layer. With reference to FIG. 8, reference plane A, which is parallel with the flattened central portion 36, forms an angle α with a tangent of reference surface B, as molded. When affixed to the seat structure as in FIG. 10, the angle α is different—approximately doubled from the as-molded angle in this particular example. This is advantageous because the layer of foam 42 could not be molded onto the decorative layer 22 in the orientation illustrated in FIG. 10, for example, without creating a die-lock condition or without the use of complex lifters or slides in the molding tool.

As such, making the layer of foam 42 discontinuous not only prevents the waste of foam material where it is not desired, it also permits the seat panel 58 to be reshaped during assembly without additional material shaping processes. In other words, omission of the relatively rigid foam on a portion of the decorative layer of material provides advantages over a continuous layer of foam, such as the ability to wrap a foam-backed fabric around bends or fold the seat panel for packaging, shipping, or into a folded configuration when applied to the seat structure. In some cases, the unprocessed portion of the decorative layer of material is stretched across a seat frame and/or backed with hard or soft materials when attached to the seat to give the seat panel 58 its final structure.

Additionally, as illustrated in FIG. 8, the width (W) of the discontinuous layer of foam 42 and of the finished seat panel 58 can be wider than the width (w) of the molding tool 10 and of the foam molding cavity 46. This enables the use of smaller molding presses and molding tools, each of which reduces costs and required space in a manufacturing facility. The discontinuous layer of foam 42 can also be molded in a single molding operation, meaning that the separate first and second portions 54, 56 of the foam layer are molded in the same molding tool at the same time with a single introduction of foamable material to the foam molding cavity.

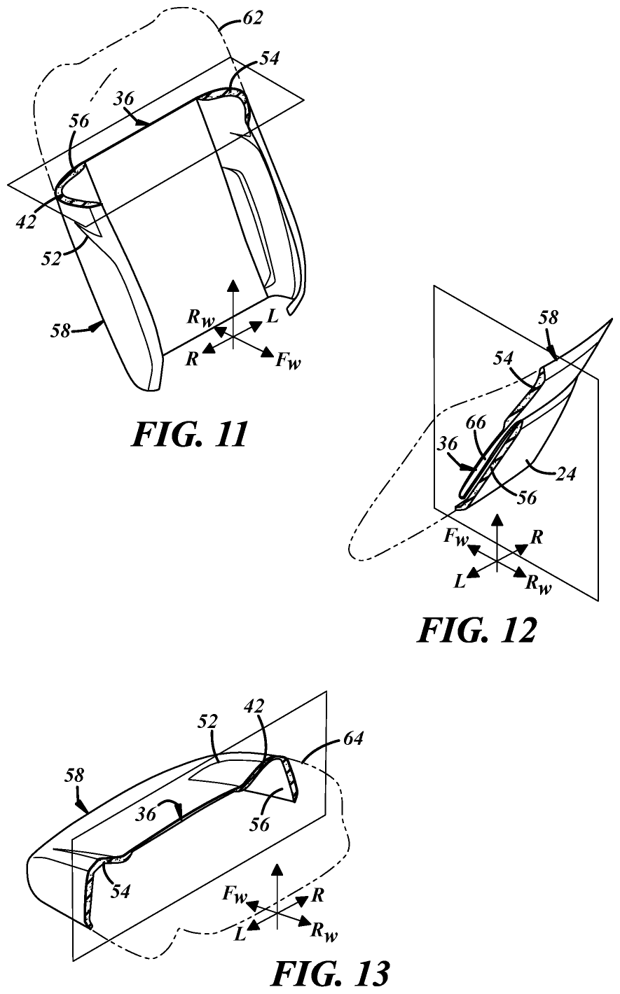

FIGS. 11-13 illustrate seat panels 58 made using embodiments of the above-described method. Each of the illustrated seat panels 58 forms a different portion of the exterior of the vehicle seat of which it is a part. Forward (Fw), rearward (Rw), left (L), and right (R) directions are labeled in the figures with respect to a seat occupant. FIG. 11 is a perspective view of the seat panel 58 as viewed from a forward-facing side of a seat back 62. An outline of the seat back 62 is shown in phantom where the top of the seat back is cut-away, and an underlying seat structure (e.g., frame and cushion) is omitted to clearly show the non-decorative side of the panel 58. The illustrated seat panel 58 is arranged along a rear-facing side of the seat back 62, similar to that of FIG. 10, with the first and second portions 54, 56 of the discontinuous layer of foam 42 extending from the central portion 36 of the decorative layer 22 and wrapping around to the opposite left and right sides of the seat back. From the perspective of FIG. 11 a sharp feature line 52 is visible in the decorative layer 22 backed by one of the portions 56 of the foam layer 42.

FIG. 12 is a perspective view of the seat panel 58 as viewed from a rear-facing side of a seat back. An outline of the seat panel 58 is shown in phantom where it is cut-away, and the underlying seat structure (e.g., frame and cushion) is omitted. In this example, the seat panel 58 is folded to form a pocket 66 between the separate portions 54, 56 of the discontinuous layer of foam when the seat panel is attached to the vehicle seat structure. A portion of a decorative side 24 of the decorative layer of material faces itself within the pocket 66 with one portion 54 of the layer of foam arranged above the pocket, the central portion 36 of the decorative layer forming the pocket, and the other portion 56 of the layer of foam overlying the pocket. The illustrated configuration can be attached to the underlying seat structure along the rear-facing side of the seat back 62 as a map pocket, for example.

FIG. 13 is a perspective view of the seat panel 58 as viewed from a top-rear side of a seat bottom 64. An outline of the seat bottom 64 is shown in phantom where it is cut-away, and the underlying seat structure (e.g., frame and cushion) is omitted. In this example, the seat panel 58 is arranged along an upward facing side of the seat bottom 64 with the first and second portions 54, 56 of the discontinuous layer of foam 42 extending from the central portion 36 of the decorative layer and wrapping over bolster portions of the seat bottom to form the opposite left and right decorative surfaces of the seat bottom. From the perspective of FIG. 13, sharp feature lines 52 are visible in the decorative layer backed by the portions 56, 58 of the foam layer 42. These are of course only examples of locations along the exterior of a vehicle seat at which the seat panel 58 can be affixed.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of making a vehicle seat comprising the step of molding a discontinuous layer of foam on a non-decorative side of a decorative layer of material to form a seat panel, wherein the seat panel is subsequently attached to a vehicle seat structure to form at least a portion of an exterior surface of the vehicle seat.

2. The method of claim 1, wherein the discontinuous layer of foam is molded in a single molding operation.

3. The method of claim 1, further comprising the step of forming a loop in the decorative layer of material between separate first and second areas of the decorative layer of material before the step of molding.

4. The method of claim 1, wherein the decorative layer of material is arranged so that a portion of the non-decorative side of the decorative layer of material is facing itself during the step of molding.

5. The method of claim 1, wherein a portion of the decorative layer of material located between separate first and second areas of the decorative layer of material is excluded from a foam molding cavity during the step of molding.

6. The method of claim 1, wherein a portion of the decorative layer of material is disposed in a foam molding cavity of a molding tool during the step of molding and another portion of the decorative layer of material is disposed in a secondary cavity of the molding tool during the step of molding.

7. The method of claim 1, wherein the discontinuous layer of foam includes a first portion molded on a first area of the decorative layer of material and a separate second portion molded on a second area of the decorative layer of material, the method further comprising forming permanent concave features in a decorative side of the decorative layer of material at said first and second areas.

8. The method of claim 1, wherein the discontinuous layer of foam is formed by transferring a continuous layer of foamable material from a transfer film to the non-decorative side of the decorative layer of material.

9. The method of claim 1, further comprising the steps of:
disposing the decorative layer of material between opposing first and second portions of an open molding tool; and
closing the molding tool to form a foam molding cavity with a portion of the decorative layer of material in the foam molding cavity,
wherein a central portion of the decorative layer of material is outside the foam molding cavity after the step of closing and during the step of molding.

10. The method of claim 9, wherein the first portion of the molding tool comprises first and second sections configured to move toward and away from each other, the method further comprising the step of disposing the central portion of the decorative layer of material between the first and second sections of the first portion of the molding tool before the step of closing.

11. The method of claim 9, wherein the decorative layer of material is in sheet form and placed in tension during the step of disposing with forces applied to opposite edges of the decorative layer of material in opposite directions and another force applied to the central portion of the decorative layer of material in a direction transverse to said opposite directions.

12. The method of claim 1, wherein separate first and second portions of the discontinuous layer of foam are on opposite left and right sides of a seat back of the vehicle seat when the seat panel is attached to the vehicle seat structure.

13. The method of claim 1, wherein separate first and second portions of the discontinuous layer of foam are on opposite left and right sides of a seat bottom of the vehicle seat when the seat panel is attached to the vehicle seat structure.

14. The method of claim 1, wherein the seat panel is folded to form a pocket between separate first and second portions of the discontinuous layer of foam when the seat panel is attached to the vehicle seat structure so that a portion of a decorative side of the decorative layer of material faces itself within the pocket.

15. The method of claim 1, wherein separate first and second portions of the discontinuous layer of foam have a first orientation relative to each other during the step of molding and a different second orientation relative to each other after attachment to the vehicle seat structure.
